(19) United States
(12) Patent Application Publication
(10) Pub. No.: US 2011/0112667 A1
(43) Pub. Date: May 12, 2011

(54) Gaming Audio Codec System and Method

(75) Inventor: James Lawrence, Henderson, NV (US)

(73) Assignee: BALLY GAMING, INC., Las Vegas, NV (US)

(21) Appl. No.: 12/618,634

(22) Filed: Nov. 13, 2009

Related U.S. Application Data
(63) Continuation-in-part of application No. 12/617,674, filed on Nov. 12, 2009.

(51) Int. Cl. G06F 17/00

(52) U.S. Cl. 700/94

(57) ABSTRACT

Various embodiments disclosed herein are directed to a method for playing an audio file using an audio codec engine system in a gaming environment. The method comprising: reading an audio file into a memory buffer only once; receiving a request from a game application to play the audio file; inputting the memory buffer into the audio codec engine to obtain a decompressed audio sample in response to the request; and decoding only a one second maximum of an audio sample at time, wherein the audio codec does not decode the entire audio file at once; and wherein an audio file's samples are decoded only when the audio file is requested for active playback by the game application.

### CROSS-REFERENCE TO RELATED APPLICATIONS

This application is a continuation-in-part of U.S. Pat. application Ser. No. 12/617,674, entitled Video Codec System and Method, filed Nov. 12, 2009, which is incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to a gaming system and, more particularly, to a system and methodology for providing an enhanced audio codec engine.

### BACKGROUND

Ogg Vorbis is the Vorbis audio codec's content delivered in the Ogg container format. Vorbis is most commonly used in conjunction with the Ogg container format, and it is therefore often referred to as Ogg Vorbis. The specification is in the public domain. Most consider Ogg Vorbis to be higher quality than MP3, with the CPU (computer processor usage) usage being quite reasonable, and significantly lower than video. Raw 16-bit, stereo sound at 44 kHz is 176 Kb per second, per game can add up is to a significant amount of memory (i.e., ten games with sixty seconds of audio each equates to roughly one Gigabyte). The Ogg Vorbis encoding tools enable a user to choose a bitrate. The Ogg Vorbis audio format specification and software implementation (codec) maintains a set of libraries that abstracts low-level details away.

Ogg is a standard container format maintained by the Xiph.Org Foundation. The Ogg format is open source and is designed to provide for efficient streaming and manipulation of high quality digital multimedia. A container format is a file format, or often a stream format (in which the stream is not stored as a file) whose specifications describe only the way data is stored (but not coded) within the file, and how much metadata could be, or is effectively stored. A container format is in fact a meta-format, since it stores the data itself, and the information about how it is stored. The name ‘Ogg’ refers to the file format which can multiplex a number of separate, independent, and open source codecs for audio, video, text (such as subtitles), and metadata.

Vorbis is an open source and created by the Xiph.Org Foundation (formerly Xiphophorus company). They produce an audio format specification and software implementation (codec) for lossy audio compression. A lossy compression method is one where compressing data and then decompressing it retrieves data that is different from the original, but is close enough to be useful in some way. Lossy compression is most commonly used to compress multimedia data (audio, video, still images), especially in applications such as streaming media and internet telephony.

Accordingly, it would be desirable to use more advanced audio and video technologies with the same or lower memory requirements as legacy server.

### SUMMARY

Briefly, and in general terms, various embodiments are directed to audio and video codec engine systems for a gaming machine. An embodiment disclosed herein is directed to a method for playing an audio file using an audio codec engine system in a gaming environment. The method comprising: reading an audio file into a memory buffer only once; receiving a request from a game application to play the audio file; inputting the memory buffer into the audio codec engine to obtain a decompressed audio sample in response to the request; and decoding only a one second maximum of an audio sample at time, wherein the audio codec does not decode the entire audio file at once; and wherein an audio file's samples are decoded only when the audio file is requested for active playback by the game application.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 illustrates a block diagram of the components of a gaming device.

FIG. 2 illustrates an existing audio server framework.

FIG. 3 illustrates a file implementation loading process.

FIG. 4 illustrates a server high level object sequence diagram.

FIG. 5 illustrates an Ogg Vorbis audio buffer logical flow diagram.

FIG. 6 illustrates one embodiment of a gaming device including the secured module for validating the BIOS.

FIG. 7 illustrates one embodiment of a gaming system network including the gaming devices of FIG. 6.

### DETAILED DESCRIPTION

Various embodiments disclosed herein are directed to gaming devices having a system and method for implementing an audio codec engine system in a gaming environment that supports the Ogg Vorbis audio format. Ogg Vorbis is similar in function to the MP3 format, but is open source and is preferred in sound quality by many users. A significant benefit of the audio codec engine system that supports the Ogg Vorbis audio format is the reduction in memory usage of the sound server, which currently inhibits game development from including large musical clips in their games.

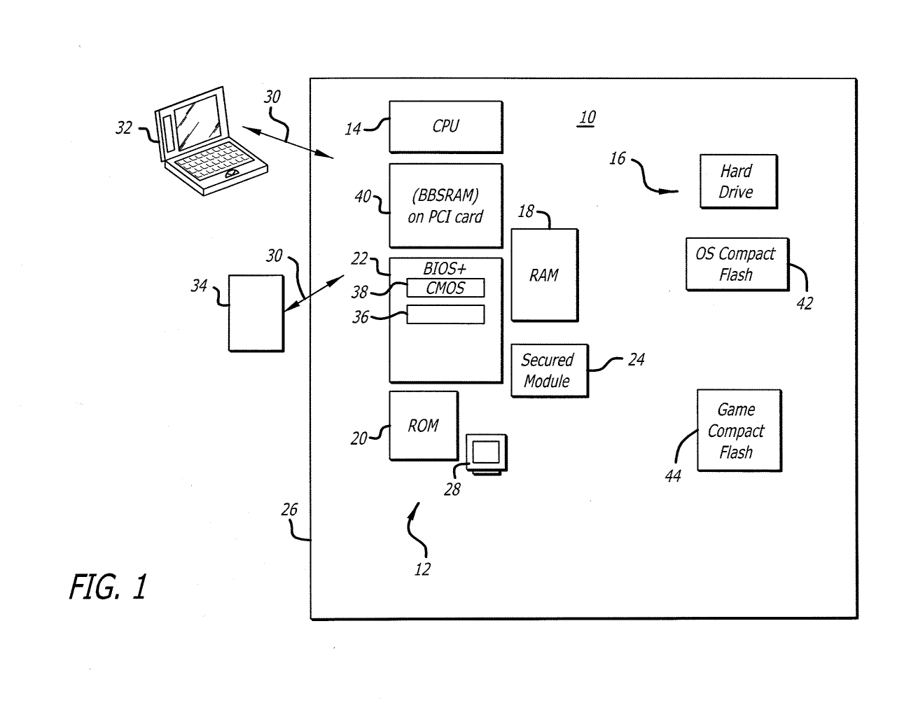

While many existing sound servers support WAV, ADPCM, and Bink audio formats, all of these formats have proven to include drawbacks and generally are less than optimal for use in a gaming environment. The use of an audio codec engine system in a gaming environment that supports the Ogg Vorbis audio format is a nice addition, since ADPCM and Bink files are too big and generally have poor music quality. In this regard, WAV files are extremely too large for this type of use. Referring now to the drawings, wherein like reference numerals denote like or corresponding parts throughout the drawings and, more particularly to FIGS. 1-5, there are shown various embodiments of a gaming system employing an Ogg Vorbis audio engine system.

FIG. 1 illustrates a block diagram of the components 12 of a gaming device 10. The components 12 comprise, for example, and not by way of limitation, software or data file components, firmware components, hardware components, or structural components of the gaming machine 10. These components include, without limitation, one or more processors 14, a hard disk device 16, volatile storage media such as random access memories (RAMs) 18, read-only memories (ROMs) 20 or electrically-erasable programmable ROMs (EEPROMS) such as basic input/output systems (BIOS) 22. Additionally, the gaming device 10 includes a secured module 24. The secured module is a hardware component that is one-time programmable. One or more security algorithms may be provided on the secured module. The security algorithm generates a challenge (e.g., generates a random number), calculates an expected response to the challenge, and determines the validity of the BIOS based on the response to the challenge provided by the BIOS. In one embodiment, the secured module is a field-programmable gate array (FPGA). In another embodiment, the secured module is a trusted platform module (TPM).

In one embodiment, components 12 also include data files (which are any collections of data, including executable programs in binary or script form, and the information those programs operate upon), gaming machine cabinets (housings) 26, displays 28, or compact disk read-only memory (CDROM) or CD read-write (CR-RW) storage. In one embodiment, the data files may include data storage files, software program files, operating system files, and file allocation tables or structures. Ports 30 are be included with the gaming machine 10 for connection to diagnostic systems 32 and other input/output devices 34. In one embodiment, the ports 30 each comprise a serial port, universal serial bus (USB) port, parallel port or any other type of known port, including a wireless port. Preferably, each of the components 12 have embedded or loaded in them identification numbers or strings that can be accessed by the processor 14, including the processor 14 itself, which are utilized for authentication as explained below. In one embodiment, the components that are data files each use their file path and name as their identification number or string.

Either within the gaming machine 10, or in the diagnostic system 32 attachable to the gaming machine 10, are executable instructions or a software program 36 for authentication of the components (authentication software 36), which itself may be one of the components 12 to authenticate if it is internal to the gaming machine 10. In one embodiment, authentication software 36 is stored on a persistent storage media such as the hard disk device 16, ROM 20, EEPROM, in a complementary metal oxide semiconductor memory (CMOS) 38, in safe RAM comprising a battery-backed static random access memory (BBSRAM) 40, in flash memory components 42, 44, or other type of persistent memory. In one embodiment, the authentication software 36 is stored in a basic input/output system (BIOS) 22 device or chip. BIOS chips 22 have been used for storing prior authentication software, such as previous versions of the BIOS+ chip used by Bally Gaming Systems, Inc. of Las Vegas, Nev. in their EVO gaming system. Placing the authentication software 36 in the BIOS 22 is advantageous because the code in the BIOS 22 is usually the first code executed upon boot or start-up of the gaming machine 10, making it hard to bypass the authentication process. Alternatively, in one embodiment, the authentication software 36 is stored in a firmware hub (FWH), such as Intel's 82802 FWH.

As an alternative, instead of, or in conjunction with, the hard disk device, another mass storage device is used, such as a CD-ROM, CD-RW device, a WORM device, a floppy disk device, a removable type of hard disk device, a ZIP disk device, a JAZZ disk device, a DVD device, a removable flash memory device, or a hard card type of hard disk device.

It should be noted that the term, gaming device, is intended to encompass any type of gaming machine, including hand-held devices used as gaming machines such as cellular-based devices (e.g., phones), PDAs, or the like. The gaming device can be represented by any network node that can implement a game and is not limited to cabinet-based machines. The system has equal applicability to gaming machines implemented as part of video gaming consoles or handheld or other portable devices. In one embodiment, a geo-location device in the handheld or portable gaming device may be used to locate a specific player for regulatory and other purposes. Geo-location techniques that can be used include by way of example, and not by way of limitation, an IP address lookup, a GPS, a cell phone tower location, a cell ID, a known Wireless Access Point location, a Wi-Fi connection used, a phone number, a physical wire or port on the client device, or by an accessed middle tier or backend server. In one embodiment, GPS and biometric devices are built within a player's client device, which in one embodiment comprises a player's own personal computing device, or is provided by the casino as an add-on device using USB, Bluetooth, IRDA, serial or another interface to the hardware to enable jurisdictionally compliant gaming, ensuring the location of play and the identity of the player. In another embodiment, the casino provides an entire personal computing device with these devices built in, such as a tablet-type computing device, PDA, a cell phone or another type of computing device capable of playing system games.

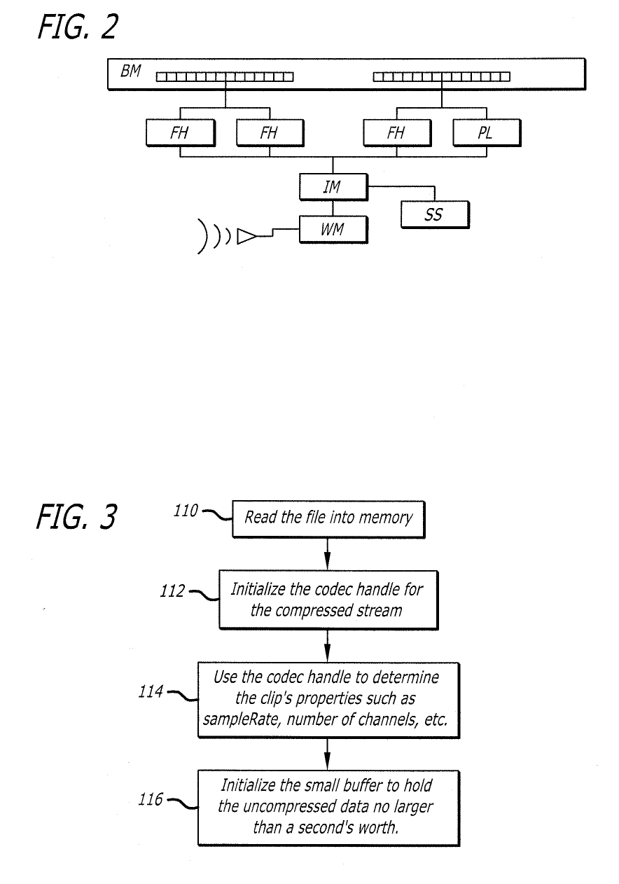

Referring now to FIGS. 2-5, in one embodiment of an audio codec engine system that supports the Ogg Vorbis audio format, an existing sound server may be enhanced by making modifications to support the Ogg Vorbis format. In such an embodiment, the game API (application program interface) connection to the sound server may remain unchanged.

In an existing audio server framework, shown in FIG. 2, consisting of the following components: Audio Buffer (AB), Buffer Manager (BM), File Handle (FH), Intermediate Mixer (IM), and Wave Mixer (WM). The Audio Buffer manages an instance of a clip of a particular format of audio content. The Buffer Manager manages the entire list of buffers of audio content. The File Handle manages an instance of a playing file with its position and state. The Intermediate Mixer manages client requests for play, pause, mute, fade, and the like. The Wave Mixer handles communications to the sound card.

In one embodiment, the audio codec engine system reads an Ogg Vorbis audio file into memory only once. When the audio file is requested for play by the game application, the memory buffer is input into the Ogg Vorbis codec to obtain decompressed samples. The implementation does not decode the entire file all at once, but at a maximum, only one second at a time. An audio file's samples are decoded only when the file is requested for active playback by the game application.

Referring now to FIG. 3, the file implementation loading process is shown using the audio codec engine system. The implementation includes first loading the Ogg Vorbis audio file into memory, Step 110. Next, the implementation process involves initializing the codec handle for the compressed stream, Step 112. Continuing, the implementation process includes using the codec handle to determine the audio clip's properties, such as the sample rate, the number of channels, and the like, Step 114. Finally, the implementation process includes initializing the small buffer to hold no larger than a second's worth of the uncompressed data, Step 116.

Furthermore, the audio codec engine system involves the implementation of a new Audio Buffer class. The Audio Buffer interface is:

Get the next sample(s) of sound.

@param fileHandle file playback instance.

void IBuffer::GetSegment (IFileHandle *fileHandle).

Gets the rate of the audio buffer.

unsigned short IBuffer::GetRate( ).

The File Handle interface is:

Get the next sample(s) of sound.

@param left value for left channel, mono channel is numOfChannels is 1.

@param right value for right channel.

@param numOfChannels number of channels, 1 for mono, 2 for stereo.

void IFileHandle::SetSegmentChannels(signed short left, signed short right, int numOfChannels).

A “segment” is a single sample for mono, with right and left channel samples for stereo.

Returns the requested sample number by index.

unsigned long IFileHandle::GetIndex( )

Notifies the handle object to increment to the next sample.

@param amount segment bytes to increment.

void IFileHandle::IncIndex(unsigned long amount).

Get the unique id for this file handle.

unsigned long IFileHandle::FHID( ).

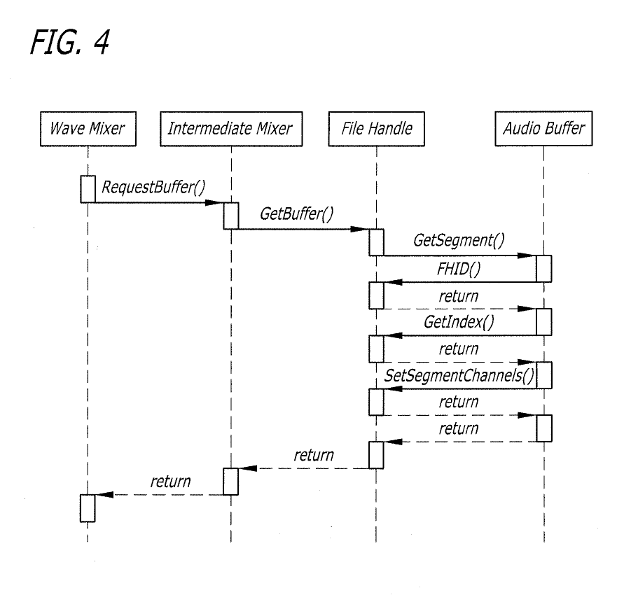

Referring now to FIG. 4, a sequence diagram for a server high level object is shown using the audio codec engine system. In one embodiment, the Wave Mixer drives the request of more data to keep the sound card's playback buffer non-empty. Next, the Intermediate Mixer loops through each open file handle to obtain the current segment of data. Continuing, the FHID( ) call uniquely identifies the playback stream instance and theGetIndex call indicates the playback position. Finally, the Audio Buffer calls SetSegmentChannels to set the sample values, as requested.

In a preferred embodiment of the audio codec engine system, each audio buffer may have multiple file instances. Additionally, each file handle instance needs its own Decoder instance. A table that holds the map from a file instance to decoder handle is also created. Continuing, the system requests samples results using the table to find the decoder handle for a particular playback instance. Further, the decoder handle is used to obtain uncompressed samples from a compressed memory buffer.

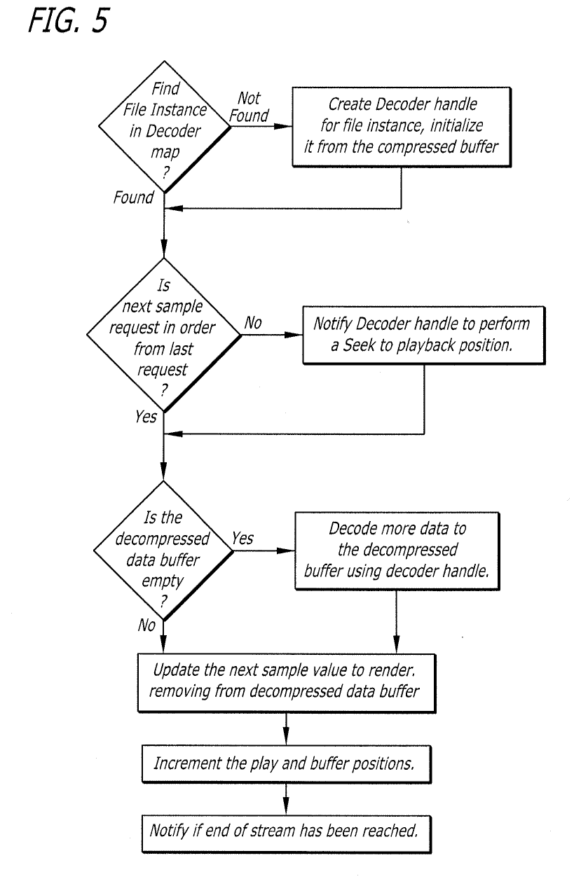

Referring now to FIG. 5, the flow chart for the Ogg Vorbis Audio Buffer class to handle the next sample request is shown using the audio codec engine system. Once the requested sample is obtained, the sound server automatically handles the rest. The processing done by the server includes sample-rate conversions, mono-to-stereo conversions, fades, rendering, and the like. In this regard, using the audio codec engine system for the support of the Ogg Vorbis audio files in a gaming environment saves significant memory for sound playback on a gaming machine.

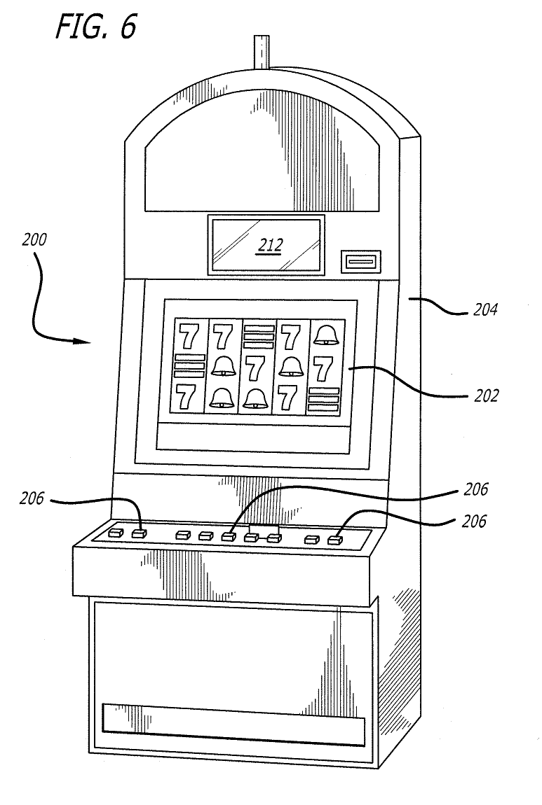

FIG. 6 illustrates one embodiment of a gaming device including the secured module for validating the BIOS. Turning to FIG. 6, the main cabinet 204 of the gaming machine 200 is a self-standing unit that is generally rectangular in shape. In another embodiment, the main cabinet 204 may be a slant-top gaming cabinet. Alternatively, in other embodiments, the gaming cabinet may be any shaped cabinet known or developed in the art that may include a top box. Additionally, the cabinet may be manufactured with reinforced steel or other rigid materials that are resistant to tampering and vandalism. Optionally, in an alternate embodiment, the gaming machine 200 may instead be a cinema-style gaming machine (not shown) having a widescreen display, as disclosed in U.S. application Ser. No. 11/225,827, entitled “Ergonomic Gaming Cabinet,” filed on Sep. 12, 2005, which is hereby incorporated by reference.

As shown in FIG. 6, the gaming machine 200 includes a main display 202. According to one embodiment, the main display 202 is a plurality of mechanical reels for presenting a slot-style game. Alternatively, the main display 202 is a video display for presenting one or more games such as, but not limited to, mechanical slots, video slots, video keno, video poker, video blackjack, video roulette, Class II bingo, games of skill, games of chance involving some player skill, or any combination thereof.

According to one embodiment, the main display 202 is a widescreen display (e.g., 16:9 or 16:10 aspect ratio display). In one embodiment, the display 202 is a flat panel display including by way of example only, and not by way of limitation, liquid crystal, plasma, electroluminescent, vacuum fluorescent, field emission, LCOS (liquid crystal on silicon), and SXRD (Silicon Xtal Reflective display), or any other type of panel display known or developed in the art. These flat panel displays may use panel technologies to provide digital quality images including by way of example only, and not by way of limitation, EDTV, HDTV, or DLP (Digital Light Processing).

According to one embodiment, the widescreen display 202 may be mounted in the gaming cabinet 204 in a portrait or landscape orientation. In another embodiment, the game display 202 may also include a touch screen or touch glass system (not shown). The touch screen system allows a player to input choices without using any electromechanical buttons 206. Alternatively, the touch screen system may be a supplement to the electromechanical buttons 206.

The main cabinet 204 of the gaming machine also houses a game management unit (not shown) that includes a CPU, circuitry, and software for receiving signals from the player-activated buttons 206 and a handle (not shown), operating the games, and transmitting signals to the respective game display 206 and speakers (not shown). Additionally, the gaming machine includes an operating system such as Bally Gaming's Alpha 05, as disclosed in U.S. Pat. No. 7,278,068, which is hereby incorporated by reference.

In various embodiments, the game program may be stored in a memory (not shown) comprising a read-only memory (ROM), volatile or non-volatile random access memory (RAM), a hard drive or flash memory device or any of several alternative types of single or multiple memory devices or structures.

As shown in FIG. 6, the gaming machine 200 includes a plurality of player-activated buttons 206. These buttons 206 may be used for various functions such as, but not limited to, selecting a wager denomination, selecting a number of games to be played, selecting the wager amount per game, initiating a game, or cashing out money from the gaming machine 200. The buttons 206 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, a touch pad, a track ball, a mouse, switches, and toggle switches, are included with the gaming machine to also accept player input. Optionally, a handle (not shown) may be “pulled” by a player to initiate a slots-based game.

One of ordinary skill in the art will appreciate that not all gaming devices will have all these components or may have other components in addition to, or in lieu of, those components mentioned here. Furthermore, while these components are viewed and described separately, various components may be integrated into a single unit in some embodiments.

In some embodiments, the gaming machine 200 is part of a gaming system connected to or with other gaming machines as well as other components such as, but not limited to, a Systems Management Server (SMS) and a loyalty club system (e.g., casino management personnel/system (CMP/CMS)). Typically, the CMS/CMP system performs casino player tracking and collects regular casino floor and player activity data. The gaming system may communicate and/or transfer data between or from the gaming machines 200 and other components (e.g., servers, databases, verification/authentication systems, and/or third party systems).

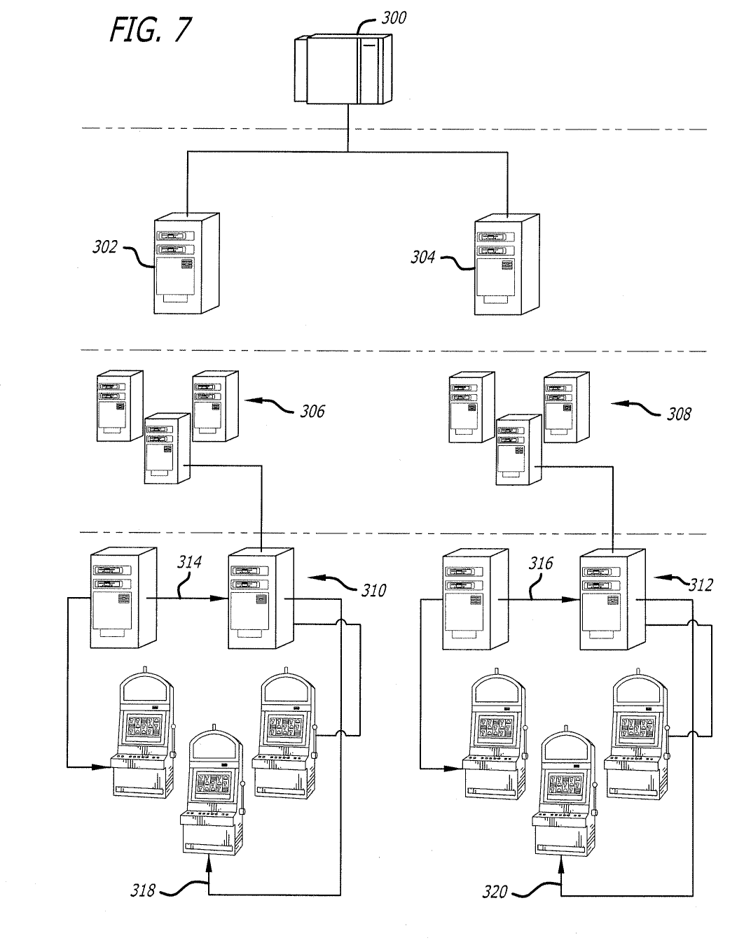

An embodiment of a network that may be used with the system is illustrated in FIG. 7. The example network consists of a top-level vender distribution point 300 that contains all packages for all jurisdictions; one or more Jurisdiction distribution points 302 and 304 that contain regulator approved production signed packages used within that jurisdiction or sub-jurisdiction; one or more Software Management Points 306 and 308 to schedule and control the downloading of packages to the gaming machine; and a one or more Software Distribution Points 310 and 312 that contain regulator approved production signed packages only used in the gaming establishment that it supports. The Software Distribution Points (SDPs) 310 and 312 can communicate with Systems Management Points (SMPs) 314 and 316, respectively as well as directly to one or more gaming machines 318 and 320. The system allows for rapid and secure distribution of new games, configurations, and OS's from a centralized point. It makes it possible to update and modify existing gaming machines with fixes and updates to programs as well as providing modifications to such files as screen images, video, sound, pay tables and other gaming machine control and support files. It provides complete control of gaming machines from a centralized control and distribution point and can minimize the need and delay of human intervention at the gaming machine. In one embodiment, the configuration control may be from the SDPs 101 or 104 or from the gaming servers 103.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for playing an audio file using an audio codec engine system in a gaming environment, the method comprising:
reading an audio file into a memory buffer only once;
receiving a request from a game application to play the audio file;
inputing the memory buffer into the audio codec engine to obtain a decompressed audio sample in response to the request; and
decoding only a one second maximum of an audio sample at a time, wherein the audio codec does not decode the entire audio file at once;
wherein an audio file's samples are decoded only when the audio file is requested for active playback by the game application.

2. The method of claim 1, wherein the audio codec engine system includes a wave mixer that drives requests for more data to keep a playback buffer of a sound card non-empty.

3. The method of claim 1, wherein the audio codec engine system includes an intermediate mixer that loops through each open file handle to obtain a current segment of data.

4. The method of claim 1, wherein the audio codec engine system includes a (1) file handle call that uniquely identifies a playback stream instance and (2) a get index call that indicates a playback position.

5. The method of claim 1, wherein the audio codec engine system includes an audio buffer that calls a set segment channel to set sample values.

6. The method of claim 1, wherein each audio buffer may have multiple file instances.

7. The method of claim 1, wherein the audio codec engine system includes a file handle, and each file handle instance needs a decoder instance.

8. The method of claim 7, wherein a table that holds a map from a file instance to decoder handle is created.

9. The method of claim 1, further comprising:
in response to a request to play audio samples, causing a table to be used to find a decoder handle for a particular playback instance; and
using the decoder handle to obtain uncompressed audio samples from a compressed memory buffer.

10. A method for file implementation loading using an audio codec engine system in a gaming machine, the method comprising.
loading an audio file into memory;
initializing a codec handle for a compressed stream;
using the codec handle to determine audio file properties, wherein audio file properties include sample rate, number of channels, and combinations thereof; and
initializing a small buffer to hold no larger than a second worth of uncompressed audio data.
